(19) United States
(12) Patent Application Publication
(10) Pub. No.: US 2017/0168659 A1
(43) Pub. Date: Jun. 15, 2017

(54) CLUSTER SYSTEM FOR VEHICLE AND METHOD OF CONTROLLING THE CLUSTER SYSTEM

(71) Applicant: HYUNDAI MOTOR COMPANY, Seoul (KR)

(72) Inventor: Jae Jung NAM, Pohang-si (KR)

(21) Appl. No.: 15/210,236

(22) Filed: Jul. 14, 2016

(30) Foreign Application Priority Data
Dec. 9, 2015 (KR) 10-2015-0174643

(51) Int. Cl. G06F 3/0481; G09G 3/20

(52) U.S. Cl. CPC G06F 3/0481; G09G 3/20

(57) ABSTRACT

A method of controlling a vehicle cluster includes sensing an object placed on the cluster, determining an area of the cluster covered by the sensed object, and changing a display layout of a display panel included in the cluster on the basis of the determined area.

This application claims the benefit of priority to Korean Patent Application No. 10-2015-0174643, filed on Dec. 9, 2015, which is hereby incorporated by reference as if fully set forth herein.

### TECHNICAL FIELD

The present disclosure relates to a vehicle cluster system for sensing an obstructing object and providing an optimized display environment, and further to a method of controlling the vehicle cluster.

### BACKGROUND

As smartphone navigation functions are increasingly used, some drivers set their smartphones in separate holders, but other drivers do not use holders. Further, a number of drivers who do not use the holders tend to lay their smartphones on the clusters of vehicles when driving the vehicles.

FIGS. 1A and 1B illustrate an example of location of a smartphone on a cluster.

When a smartphone 200 is placed on the lower part of a housing of a cluster 100, as shown in FIG. 1A, a part 200′ of the cluster, which corresponds to the smartphone, may be covered, as shown in FIG. 1B. In this case, while the driver can use a navigation function of the smartphone during driving, warnings or information that needs to be transferred to the driver, such as a battery/engine oil warning light 111 or an engine/tire pressure warning light 112, may be blocked by the smartphone, causing inconvenience and possible adverse situations.

### SUMMARY

An object of the present disclosure devised to solve the problem lies in a cluster system capable of providing information necessary for a driver even when an object covering the cluster of a vehicle is present, and a method of controlling the same.

Particularly, the present disclosure provides a cluster system capable of providing information necessary for a driver on the basis of the size and position of an object that covers the cluster of a vehicle, and a method of controlling the same.

Technical tasks obtainable from the present disclosure are not limited to the above-mentioned technical task. In addition, other unmentioned technical tasks can be clearly understood from the following description by those having ordinary skill in the technical field to which the present disclosure pertains.

In an aspect of the present disclosure to accomplish the object, a method of controlling a vehicle cluster may include: sensing an object placed on the cluster; determining an area of the cluster covered by the sensed object; and changing a display layout of a display panel included in the cluster on the basis of the determined area.

In another aspect of the present disclosure, a cluster system for a vehicle may include: a cluster including a display panel; a sensing unit for sensing an object placed on the cluster; and a controller for determining an area of the cluster covered by the sensed object and controlling a display layout of the display panel to be changed on the basis of the determined area.

The present disclosure has the following advantages.

It is possible to effectively deliver information necessary for a driver since display of the cluster is changed in consideration of information displayed in an area covered by an object in front of the cluster.

It is also possible to effectively provide changed display information since the size and position of the object that covers the cluster are considered.

The effects of the present disclosure are not limited to the above-described effects, and other effects which are not described herein will become apparent to those skilled in the art from the following description.

### BRIEF DESCRIPTION OF THE DRAWINGS

FIGS. 1A and 1B illustrate an example of a location of a smartphone on a cluster according to an embodiment of the present disclosure.

FIG. 2 is a flowchart illustrating an exemplary cluster system control method accounting for an object in front of a cluster according to an embodiment of the present disclosure.

FIGS. 3A and 3B illustrate an exemplary configuration of a sensing unit according to embodiments of the present disclosure.

FIGs . 4A to 4C illustrate an exemplary process of determining a cluster area covered by an object using a sensing unit according to an embodiment of the present disclosure.

FIGS. 5A to 5D illustrate an exemplary process through which a cluster display layout is changed according to an embodiment of the present disclosure.

FIG. 6 is a block diagram illustrating an exemplary configuration of a cluster system according to an embodiment of the present disclosure.

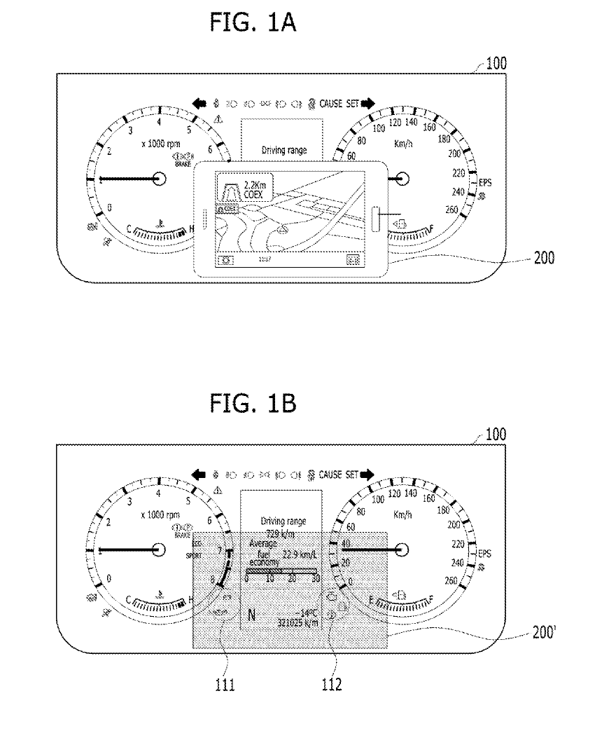

### DETAILED DESCRIPTION

The present disclosure will now be described in detail with reference to the attached drawings. The same reference numbers will be used throughout this specification to refer to the same or like parts. The terms “module” and “unit” used to signify components are used herein to aid in the understanding of the components and thus they should not be considered as having specific meanings or roles.

In the following description of the present disclosure, a detailed description of known functions and configurations incorporated herein will be omitted when such a detailed description may obscure the subject matter of the present disclosure. The accompanying drawings illustrate exemplary embodiments of the present disclosure and provide a more detailed description of the present disclosure. However, the scope of the present disclosure should not be limited thereto. It should be understood that there is no intent to limit the disclosure to the particular forms disclosed herein. On the contrary, the disclosure covers all modifications, equivalents, and alternatives falling within the spirit and scope of the disclosure as defined by the claims.

According to an embodiment of the present disclosure, when an object covers a display screen of a cluster of a vehicle, the cluster may sense the object and change a display layout in response to the object so as to effectively transfer information necessary for the driver.

To this end, a display panel (e.g. LCD, LED panel, OLED panel or the like) that can freely change a display layout in at least part of the display may be applied to, or included with, the cluster. For example, the cluster according to a present embodiment may be a full LCD cluster that displays information indicated by a speedometer or a tachometer through a display or a cluster including a speedometer and a tachometer of an analog needle type and a display panel provided between the speedometer and the tachometer. In both cases, some warning lights, or other signals, may be configured as toggle type warning lights at fixed positions.

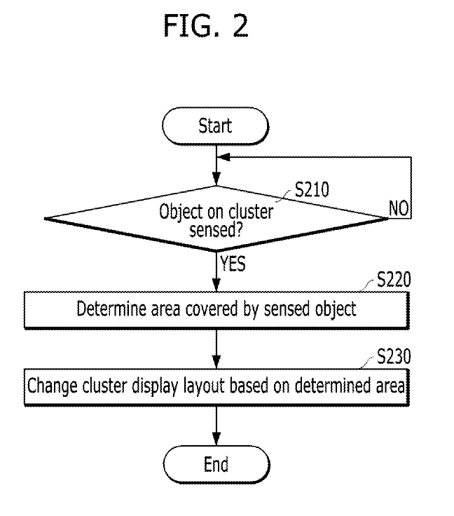

FIG. 2 is a flowchart illustrating a cluster system control method of accounting for an object in front of a cluster according to an embodiment of the present disclosure.

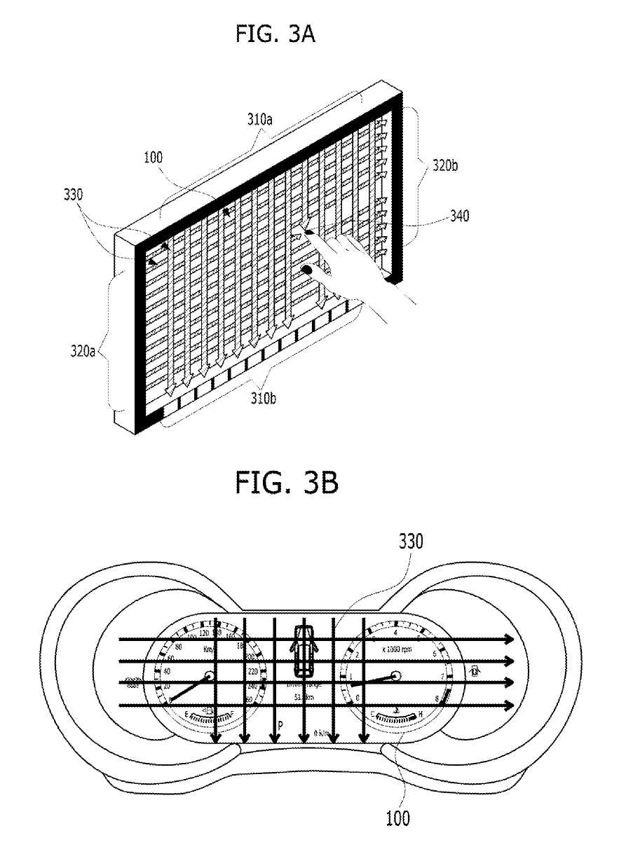

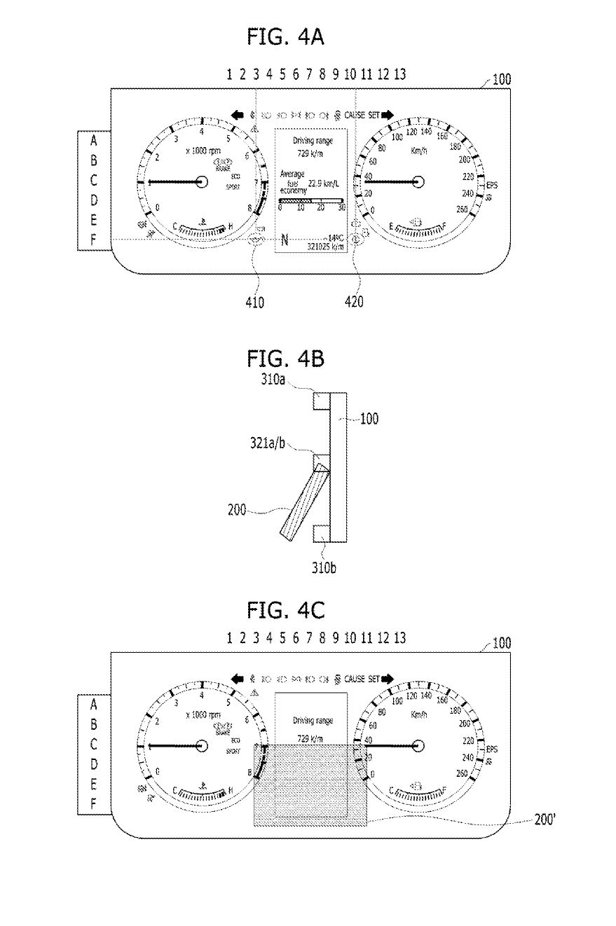

Referring to FIG. 2, an object placed on the cluster may be sensed (S210). The object may be sensed using a predetermined sensing means. The sensing means will be described in detail later with reference to FIG. 3.

When an area of the cluster covered by the object, is determined (S220), a display layout of the cluster may be changed on the basis of the determined area (S230).

Here, the change of the cluster display layout may refer to a movement of at least a part of information displayed in the area determined to be covered to an uncovered area of the display panel and displayed thereon. The information displayed in the covered area may not be information displayed on the display panel. For example, when a toggle type engine warning light disposed at a fixed position is located in the area determined to be covered, not in the display panel, a display object that executes the same function as the engine warning light may be displayed in an uncovered area of the display panel.

In addition, the change of the cluster display layout may mean not only change of the position of information displayed in the covered area, but also change of the size and layout of the information.

A description will be given of the sensing means (referred to as a “sensing unit” hereinafter) applicable to an embodiment.

The sensing unit may sense the presence of an object (i.e. smartphone) covering at least part of the cluster and the position thereof, and transmit information about the object to a controller. Since the object covering the cluster may be assumed to be an object that is not the body of a person, it may be desirable to employ a light beam matrix based sensing method rather than a capacitive or resistive sensing method. A light beam matrix based sensing unit structure will now be described with reference to FIG. 3.

FIGS. 3A and 3B illustrate an exemplary configuration of a sensing unit according to an embodiment of the present disclosure.

Referring to FIG. 3A, the sensing unit according to an embodiment may be arranged in a bezel (frame) of the cluster 100. More specifically, the sensing unit may include a pair of light-emitting units 310a and 320a and a pair of light-receiving units 310b and 320b for sensing light beams emitted from the light-emitting units 310a and 320a. The light-emitting units and the light-receiving units may be arranged opposite from each other so as to generate a light beam grid 330 on the front side of the cluster, as shown in FIG. 3B.

If an object contacts (or sufficiently approaches) the cluster display screen, light beams emitted from the light-emitting units may be blocked by the object. In such a case, light-receiving elements of the light-receiving units, which correspond to a contact portion 340, cannot, or do not, sense light beams. Accordingly, the position of the object can be sensed through x and y coordinates of the light-receiving elements that cannot, or do not, receive light beams.

Since the numbers of light-emitting elements and light-receiving elements respectively arranged in the light-emitting units and the light-receiving units may depend on coordinate accuracy, it may be desirable that the number of light-emitting element-light-receiving element pairs (referred to as “sensors” hereinafter for convenience) be determined in consideration of the number of pieces of information/warning lights covered by the smartphone when the smartphone is placed on the cluster. The light beam may be infrared light or visible light.

A description will be given of a process of determining an area covered by an object with reference to FIGS. 4A to 4C.

FIGS. 4A to 4C illustrate an exemplary process of determining a cluster area covered by an object using a sensing unit according to an embodiment of the present disclosure.

In FIG. 4A, it may be assumed that the sensing unit includes 6 sensors arranged in a vertical direction and 13 sensors arranged in a horizontal direction.

An embodiment may assume that the cluster controller recognizes positions of warning lights and information. For example, the controller may recognize that an engine oil warning light 410 is positioned at coordinates of (3, F) and a tire pressure warning light 420 is positioned at coordinates (11, F) in FIG. 4A.

When the smartphone 200, or another object, is placed on the cluster to use the navigation function thereof, or for another reason, an upper end of the smartphone 200 may contact the cluster 100, as shown in FIG. 4B. Accordingly, the smartphone 200 may block light beams emitted from the light-emitting unit 310a which may be emitting light beams in the vertical direction (i.e. arranged in the horizontal direction), which may correspond to the horizontal length of the smartphone 200. However, the smartphone 200 may block light beams emitted from a light-emitting element 321a that emits light beams in the horizontal direction and correspond to an upper end of the smartphone 200.

Accordingly, the sensing unit may acquire only the y-coordinate corresponding to the upper end of the smartphone, and thus the controller may determine that an entire area under the sensed y-coordinate is covered by the smartphone in order to correctly determine the actually covered area.

For example, when the area in which the object sensed by the sensing unit is positioned ranges from coordinates (4, C) to (11, C), as shown in FIG. 4C, the controller may determine that an area 200′ including coordinates (4, C), (4, D), (4, E) and (4, F) to (11, C), (11, D), (11, E) and (11, F) is covered by the object. Accordingly, the controller may determine that TPMS fail, check engine, low fuel, battery charge, oil pressure, average fuel consumption, outdoor temperature, gearshift state, total vehicle miles traveled, speed gauge (or a part thereof) and an RPM gauge (or a part thereof) are covered by the object.

Upon determination of the area covered by the object, as described above, it may be necessary to determine information/warning lights which correspond to the covered area and will be displayed on the display panel. To this end, information/warning lights may be divided into a plurality of groups according to priority and display of the groups may be divided into a plurality of display states according to a present embodiment.

For example, information/warning lights may be divided into three groups (A, B and C) according to priority. Specifically, a warning light that must be indicated to the driver during driving may be included in group A and must be displayed (when a lighting condition is met). Groups B and C may include information that is not directly connected to safety but is useful for the driver.

An example of such groups is shown in Table 1.

TABLE 1

| | Outline | Example |
|---|---|---|
| Group A | Warning lights such as | TMPS, engine warning |
| (warning | important symbols that | light, battery warning |
| lights) | need to be indicated | light, engine oil warning |
| | to the driver when | light, fuel warning light |
| | lighting condition is | and airbag warning light |
| | met | |
| Group B | Relatively important | Mileage available and |
| (primary | information in driving | shift lever |
| information) | (Information | |
| | frequently checked | |
| | during driving) | |
| Group C | Information which is | Average fuel consumption, |
| (General | not important for | outdoor temperature, |
| information) | driving | vehicle mileage and USM |
| | (Information which is | information |
| | not frequently checked | |
| | during driving) | |
| Others | Information indicated | odometer, speedometer, |
| (gauges) | through gauges | fuel gauge |

In addition, the controller may calculate an area in which information may be displayed when a display layout is changed by calculating a distance between a position of the sensed object and an upper end of a cluster display window for warning light/information display according to priority, and classify warning light/information display into a plurality of display states as shown in Table 2.

TABLE 2

| | Area displayed | |
|---|---|---|
| | on the cluster | |
| | after the | |
| | smartphone is | |
| | placed thereon | Display method |
| STATE 1 | Sufficient to | All groups A/B/C are displayed in |
| | display all | the LCD area of the cluster. |
| | groups A/B/C | |
| STATE 2 | Insufficient | All groups A/B/C are displayed in |
| | although all | the LCD area of the cluster (with |
| | groups A/B/C can | character line spacing reduced). |
| | be displayed | |
| STATE 3 | Available to | Only groups A/B are displayed in the |
| | display only | LCD area of the cluster. |
| | groups A/B | |
| STATE 4 | Insufficient | Only groups A/B are displayed in the |
| | although groups | LCD area of the cluster (with |
| | A/B can be | character line spacing reduced). |
| | displayed | |
| STATE 5 | Available to | Only group A is displayed in a |
| | display only | warning light group positioned at |
| | group A | the upper end of the cluster LCD. |
| Gauges | — | Gauge start point is moved and scale |
| | | is reduced on the basis of |
| | | smartphone sensing unit (available |
| | | for full LCD cluster only). |

A detailed description will be given of a change of a cluster display layout according to the aforementioned grouping and display state classification.

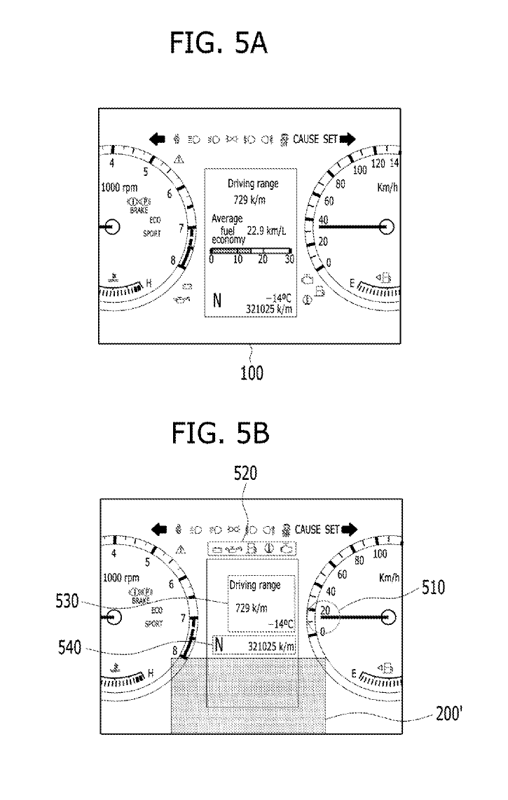

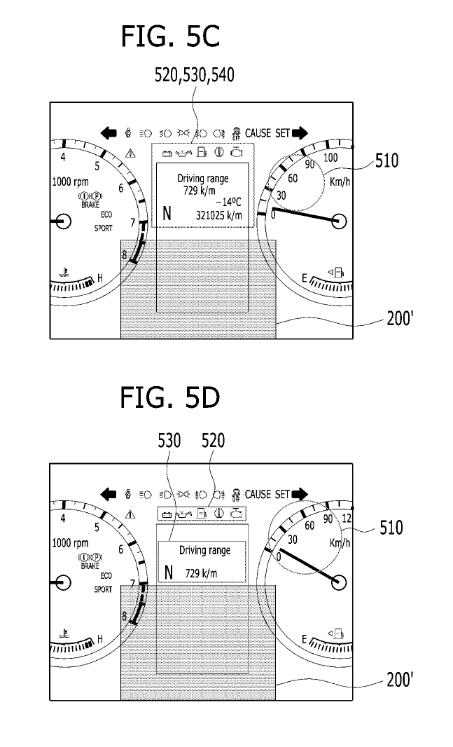

FIGS. 5A to 5D illustrate a process through which a cluster display layout is changed according to an embodiment of the present disclosure.

In FIGS. 5A to 5D, the cluster may be assumed to be a full LCD cluster.

FIG. 5A shows the cluster 100 having an unchanged display layout since no object in front of the cluster 100 is sensed.

When a smartphone is placed on the cluster, as shown in FIG. 5B, the controller may determine an area 200′ covered by the smartphone through the sensing unit. As a result, the controller may move warning lights 520 corresponding to group A, information 530 corresponding to group B and information 540 corresponding to group C to an uncovered area and display the warning lights and information therein upon determining that the area 200′ corresponds to display state 1 and information/warning lights corresponding to groups A, B and C are covered. In addition, the controller may move a start point, or another section or point, of the speed gauge.

When the covered area 200′ corresponds to display state 2, as shown in FIG. 5C, the information and warning lights 520, 530 and 540 corresponding to groups A, B and C may be moved to an uncovered area and displayed therein, similarly to FIG. 5B. However, spacing between the information/warning lights may be reduced since the uncovered area may be decreased compared to the case of FIG. 5B. In addition, the start point, or another point or section, of the speed gauge 510 may be moved up, or to a different location, and a scale interval thereof may be changed from 20 to 30.

When the covered area 200′ increases and thus corresponds to display state 3, as shown in FIG. 5D, display of group C can be omitted and information/warning lights corresponding to groups 520 and 530 may be displayed. In addition, the start point, or another point or section, of the speed gauge can be moved further upward.

When the covered area 200′ corresponds to display state 4, which is not shown, spacing between groups A and B may be further reduced. When the covered area 200′ corresponds to display state 5, only the warning lights corresponding to group A may be displayed.

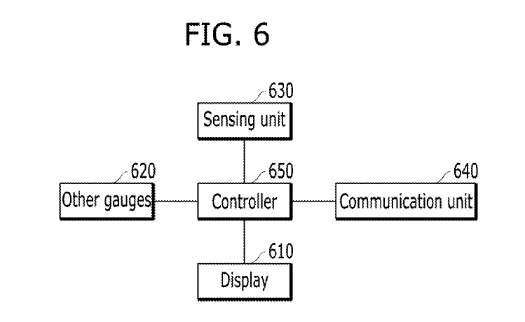

A description will be given of a structure of a cluster system capable of performing aspects of an embodiment with reference to FIG. 6.

FIG. 6 is a block diagram illustrating an exemplary configuration of a cluster system according to an embodiment of the present disclosure.

Referring to FIG. 6, the cluster system according to the present disclosure may include a display (or display panel) 610 which forms part of the cluster and displays information and warning lights, other gauges 620 for displaying information (e.g. a speedometer/tachometer and toggle type warning lights) which are not displayed on the display 610, a sensing unit 630 for sensing the size and position of an object in front of the cluster, a communication unit 640 for exchanging information with other controllers included in the corresponding vehicle and a controller 650 for controlling the aforementioned components and changing a display layout of the display 610 on the basis of the size and position of an object sensed by the sensing unit.

In general, the display 610 and the other gauges 620 may be called a “cluster” and the other gauges 620 may be omitted when the display 610 is a full LCD type display.

The present disclosure may be implemented as code that can be written to, or in, a computer-readable recording medium and can thus be read by a computer. The computer-readable recording medium may be any type of recording device in which data can be stored in a computer-readable manner. Examples of the computer-readable recording medium may include an HDD (Hard Disk Drive), an SSD (Solid State Drive), SDD (Silicon Disc Drive), a ROM, a RAM, a CD-ROM, a magnetic tape, a floppy disk, optical data storage and/or a carrier wave (e.g., data transmission over the Internet).

Those skilled in the art will appreciate that the present disclosure may be carried out in other specific ways than those set forth herein without departing from the spirit and characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A method of controlling a vehicle cluster, comprising:
sensing an object placed on the cluster;
determining an area of the cluster covered by the sensed object; and
changing a display layout of a display panel included in the cluster on the basis of the determined area.

2. The method according to claim 1, wherein the step of sensing the object is performed by a sensing unit generating a light beam grid on the cluster, and the sensing unit sensing points in the light beam grid at which light beams are blocked by the object.

3. The method according to claim 2, wherein the sensing unit comprises:
a first light-emitting unit including a plurality of light-emitting elements arranged at a first edge of a cluster frame along a horizontal direction;
a first light-receiving unit including a plurality of light-receiving elements arranged at a second edge of the cluster frame along the horizontal direction, the second edge being opposite the first edge;
a second light-emitting unit including a plurality of light-emitting elements arranged at a third edge of the cluster frame along a vertical direction; and
a second light-receiving unit including a plurality of light-receiving elements arranged at a fourth edge of the cluster frame along the vertical direction, the fourth edge being opposite the third edge.

4. The method according to claim 3, wherein the step of determining the covered area comprises:
determining horizontal coordinates of the object using the first light-emitting unit and the first light-receiving unit;
determining vertical coordinates of the object using the second light-emitting unit and the second light-receiving unit; and
determining the covered area of the cluster by combining the horizontal coordinates and the vertical coordinates.

5. The method according to claim 4, wherein the step of determining the covered area of the cluster by combining the horizontal coordinates and the vertical coordinates comprises determining that all vertical coordinates beneath the uppermost coordinate from among the determined vertical coordinates are included in the covered area of the cluster.

6. The method according to claim 1, wherein the step of changing the display layout comprises moving at least part of information and warning lights included in the covered area of the cluster to an area uncovered by the object in the display panel of the cluster and displaying the information and warning lights therein.

7. The method according to claim 6, wherein the step of displaying at least part of information and warning lights included in the covered area of the cluster comprises changing and displaying sizes and layout of the at least part of information and warning lights included in the covered area of the cluster.

8. The method according to claim 6, wherein the information and warning lights moved and displayed are divided into predetermined groups and whether the information and warning lights are displayed is determined based on the group determination.

9. The method according to claim 8, wherein whether the information and warning lights are displayed is determined in consideration of the size of the area uncovered by the object in the display panel of the cluster.

10. The method according to claim 6, wherein, when the cluster is of a full LCD type, the changing and displaying of the sizes and layout of the at least part of the information and warning lights comprises changing and displaying at least one of a start point and a scale of a speed gauge.

11. A cluster system for a vehicle, comprising:
a cluster including a display panel;
a sensing unit for sensing an object placed on the cluster; and
a controller for determining an area of the cluster covered by the sensed object and controlling a display layout of the display panel to be changed on the basis of the determined area.

12. The cluster system according to claim 11, wherein the sensing unit generates a light beam grid on the cluster, and the sensing unit senses points in the light beam grid at which light beams are blocked by the object.

13. The cluster system according to claim 12, wherein the sensing unit comprises:
a first light-emitting unit including a plurality of light-emitting elements arranged at a first edge of a cluster frame along a horizontal direction;
a first light-receiving unit including a plurality of light-receiving elements arranged at a second edge of the cluster frame in the horizontal direction, the first edge being opposite the second edge;
a second light-emitting unit including a plurality of light-emitting elements arranged at a third edge of the cluster frame in a vertical direction; and
a second light-receiving unit including a plurality of light-receiving elements arranged at a fourth edge of the cluster frame in the vertical direction, the fourth edge being opposite the third edge..

14. The cluster system according to claim 13, wherein the controller determines horizontal coordinates of the object using the first light-emitting unit and the first light-receiving unit, determines vertical coordinates of the object using the second light-emitting unit and the second light-receiving unit and determines the covered area of the cluster by combining the horizontal coordinates and the vertical coordinates.

15. The cluster system according to claim 14, wherein the controller determines that all vertical coordinates beneath the uppermost coordinate from among the determined vertical coordinates are included in the covered area of the cluster.

16. The cluster system according to claim 11, wherein the controller controls at least part of information and warning lights included in the covered area of the cluster to be displayed in an area uncovered by the object in the display panel.

17. The cluster system according to claim 16, wherein the controller controls sizes and layout of the at least part of information and warning lights included in the covered area of the cluster to be changed and displayed.

18. The cluster system according to claim 16, wherein the information and warning lights moved and displayed are divided into predetermined groups and whether the information and warning lights are displayed is determined based on the group determination.

19. The cluster system according to claim 18, wherein whether the information and warning lights are displayed is determined in consideration of the size of the area uncovered by the object in the display panel of the cluster.

20. The cluster system according to claim 16, wherein, when the cluster is of a full LCD type, the controller controls at least one of a start point and scale of a speed gauge to be changed and displayed.
